(19) United States
(12) Patent Application Publication
(10) Pub. No.: US 2023/0098157 A1
(43) Pub. Date: Mar. 30, 2023

(54) MANAGEMENT METHODS AND SYSTEMS FOR ELECTRIC VEHICLE CHARGING EQUIPMENT

(71) Applicant: Noodoe Corporation, Taipei City (TW)

(72) Inventors: Yi-An Hou, Taipei City (TW); Chun-Hung Kung, Taipei City (TW); Chia-Hua Chang, Taipei City (TW)

(21) Appl. No.: 17/828,097

(22) Filed: May 31, 2022

(30) Foreign Application Priority Data
Sep. 30, 2021 (TW) 110136376

(51) Int. Cl. B60L 53/68; G05B 15/02; B60L 53/30; B60L 53/66; G07C 5/00

(52) U.S. Cl. CPC B60L 53/68; G05B 15/02; B60L 53/305; B60L 53/665; G07C 5/006; G07C 5/008

(57) ABSTRACT

Management methods and systems for electric vehicle charging equipment are provided. A server is used to determine whether a specific electric vehicle charging equipment is in an abnormal state, wherein the specific electric vehicle charging equipment is bound to a specific account and can only accept a charging request from the specific account. When the specific electric vehicle charging equipment is in an abnormal state, the server activates a charging replacement mechanism for the specific account. The server sends an abnormality notification message to a mobile device corresponding to the specific account via a network, wherein the abnormality notification message is used to notify a specific user of the specific account that the specific electric vehicle charging equipment is currently abnormal, and the charging replacement mechanism for the specific account in a predetermined period.

### BACKGROUND OF THE INVENTION

### Field of the Invention

The disclosure relates generally to management methods and systems for electric vehicle charging equipment, and, more particularly to management methods and systems for electric vehicle charging equipment that can provide an alternative mechanism when the charging equipment exclusive to a user is abnormal.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Generally, most of the power equipment in the field has already been constructed. It is expensive to update the power equipment, such as the capacity of the electric panel, and the construction time is very time-consuming. The number of electric vehicle charging stations that can be installed in a single charging field is limited by the existing maximum load capacity of the field. Therefore, in the case of limited electric vehicle charging stations, electric vehicle drivers may spend time waiting because the charging station is in use, or need to search for other nearby charging stations for charging operations, resulting in inconvenience in use, thereby reduce the willingness to drive an electric vehicle.

On the other hand, the charging scenarios of electric vehicles in a centralized residence, such as a community, will be more complicated than that of a general residence. In addition to the fact that the overall electricity consumption of the community is limited by the existing maximum load capacity, it is impossible to provide all households with electric vehicle charging stations. Since some households may have mechanical parking spaces, mechanical parking spaces are difficult to set up residents' private electric vehicle charging stations under the existing technology. Therefore, residents with mechanical parking spaces can only use public electric vehicle charging stations in the community, or must go to electric vehicle charging stations outside the community to charge their electric vehicles.

Further, different types of households may have different charging behaviors and patterns. For example, community residents may be tenants, and not all tenants have the need to charge electric vehicles. If the limited electric vehicle charging stations can be provided to the tenants who really have charging needs, the management of electric vehicle charging in the community will be more effective. Therefore, how to reduce the difficulty of installation and management of electric vehicle charging stations in the community and meet the charging needs of different households will be an urgent issue for the industry to solve. In addition, how to provide charging alternatives when the equipment is abnormal to continuously meet the charging needs of users is also the key to maintaining the long-term loyalty and satisfaction of users.

### BRIEF SUMMARY OF THE INVENTION

In an embodiment of a management method for electric vehicle charging equipment is provided. First, a server is used to determine whether a specific electric vehicle charging equipment is in an abnormal state, wherein the specific electric vehicle charging equipment is bound to a specific account and can only accept a charging request from the specific account. When the specific electric vehicle charging equipment is in an abnormal state, the server activates a charging alternative mechanism for the specific account. The server sends an abnormality notification message to a mobile device corresponding to the specific account via a network, wherein the abnormality notification message is used to notify a specific user of the specific account that the specific electric vehicle charging equipment is currently abnormal, and the charging alternative mechanism for the specific account in a predetermined period.

An embodiment of a management system for electric vehicle charging equipment comprises a mobile device, a specific electric vehicle charging equipment, and a server. The mobile device corresponds to a specific user with a specific account. The specific electric vehicle charging equipment binds to the specific account, and only accepting charging requests corresponding to the specific account. The server connects to the specific electric vehicle charging equipment via a network, and determines whether a specific electric vehicle charging equipment is in an abnormal state. When the specific electric vehicle charging equipment is in an abnormal state, the server activates a charging alternative mechanism for the specific, and sends an abnormality notification message to a mobile device corresponding to the specific account via a network, wherein the abnormality notification message is used to notify a specific user of the specific account that the specific electric vehicle charging equipment is currently abnormal, and the charging alternative mechanism for the specific account in a predetermined period.

In some embodiments, the server further performs a troubleshooting operation for the specific electric vehicle charging equipment when the specific electric vehicle charging equipment is in the abnormal state, wherein the troubleshooting operation comprises a step of sending a restart command to the specific electric vehicle charging equipment via the network, thus to instruct the specific electric vehicle charging equipment to perform a restart operation, determines whether the specific electric vehicle charging equipment has returned to a normal state, and activates the charging alternative mechanism for the specific account by the server when the specific electric vehicle charging equipment does not return to the normal state.

In some embodiments, the server further sends an equipment abnormality message to at least one management terminal when the specific electric vehicle charging equipment does not return to the normal state, wherein the equipment abnormality message comprises information corresponding to the specific electric vehicle charging equipment, and in response to a response from the management terminal, activates the charging alternative mechanism for the specific account by the server.

In some embodiments, the charging alternative mechanism comprises a charging fee waiver mechanism, and the mobile device further scans a quick response code corresponding to at least one candidate electric vehicle charging equipment to send a charging request corresponding to the candidate electric vehicle charging equipment to the server via the network, wherein the charging request comprises the information corresponding to the specific account, and the server transmits a charging authorization instruction to the candidate electric vehicle charging equipment via the network to allow the candidate electric vehicle charging equipment to perform a charging operation, determines whether a receiving time of receiving the charging request falls within the predetermined period, and waives a charging fee corresponding to the charging operation when the receiving time of receiving the charging request falls within the predetermined period.

In some embodiments, the server further retrieves the at least one candidate electric vehicle charging device according to a location of the specific electric vehicle charging equipment or a historical charging record corresponding to the specific account, and transmits information corresponding to the at least one candidate electric vehicle charging equipment to the mobile device via the network.

In some embodiments, the charging alternative mechanism comprises an equipment substitution mechanism, and the server further determines whether a charging field corresponding to the specific electric vehicle charging equipment has a substitute electric vehicle charging equipment that has not been bound to any account, and binds the substitute electric vehicle charging equipment to the specific account during the predetermined period, and sets the substitute electric vehicle charging equipment can only accept the charging request corresponding to the specific account during the predetermined period when there is the substitute electric vehicle charging equipment that has not been bound to any account in the charging field.

In some embodiments, the server further determines whether the specific electric vehicle charging equipment has returned to a normal state, and cancels the charging alternative mechanism corresponding to the specific account when the specific electric vehicle charging equipment returns to the normal state.

Management methods for electric vehicle charging equipment may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a management system for electric vehicle charging equipment of the invention;

FIG. 2 is a schematic diagram illustrating an embodiment of an electric vehicle charging station of the invention:

FIG. 3 is a schematic diagram illustrating an embodiment of a server of the invention;

FIG. 4 is a flowchart of an embodiment of a management method for electric vehicle charging equipment of the invention:

FIG. 5 is a flowchart of another embodiment of a management method for electric vehicle charging equipment of the invention:

FIG. 6 is a flowchart of another embodiment of a management method for electric vehicle charging equipment of the invention;

FIG. 7 is a flowchart of an embodiment of a charging alternative mechanism of the invention; and

FIG. 8 is a flowchart of another embodiment of a charging alternative mechanism of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

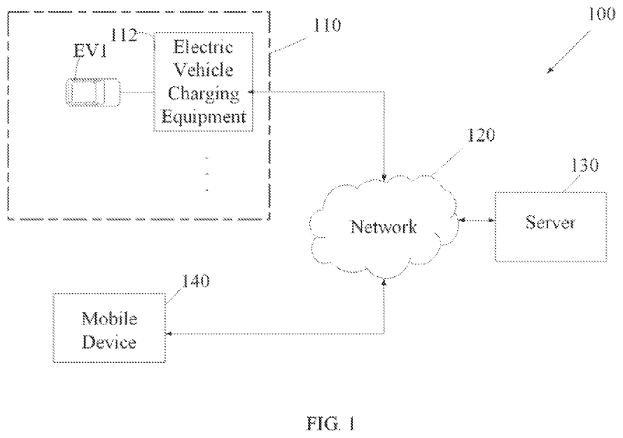

FIG. 1 is a schematic diagram illustrating an embodiment of a management system for electric vehicle charging equipment of the invention. The management system for electric vehicle charging equipment 100 is applicable to at least one electric vehicle charging equipment. It is understood that, in some embodiments, the electric vehicle charging equipment may be located within a charging field 110. For example, the charging field 110 may be a MDU (Multiple Dwelling Unit), a community, a building, a parking lot, or a shopping mall. Note that, in some embodiments, the charging field 110 may have a power limit. As shown in FIG. 1, the management system for electric vehicle charging equipment 100 of the present invention includes at least one electric vehicle charging equipment 112, and a server 130 connected to the electric vehicle charging equipment 112 via a network 120. The electric vehicle charging equipment 112 can provide the electric vehicle EV1 to perform a charging operation. In some embodiments, the network 120 may be a wired network, a telecommunication network, a wireless network, such as a Wi-Fi network, or the like. The server 130 can receive various data from the electric vehicle charging equipment via the network 120, and transmit relevant signals to the electric vehicle charging equipment. The electric vehicle charging equipment can perform related operations according to the signals received from the server 130. For example, when the electric vehicle EV1 is coupled to the electric vehicle charging equipment 112 through a charging gun of the electric vehicle charging equipment 112 to perform a charging operation, the electric vehicle charging equipment 112 can charge the electric vehicle EV1 for the charging operation. The charging information is transmitted via the network 120, and the server 130 can receive the charging information of the corresponding charging operation from the electric vehicle charging equipment 112 via the network 120. In some embodiments, the charging information may include at least a charging start time, a charging period, an output power, and/or related information indicating whether a load adjustment operation is being performed. The server 130 can know the usage status of the corresponding electric vehicle charging station according to the charging information.

It is noted that the user can connect the electric vehicle EV1 and the charging equipment 112 to each other, such as inserting a charging gun into the charging port of the electric vehicle to send a charging request corresponding to the charging equipment 112 to use the charging equipment 112. The charging equipment 112 performs a charging operation for the electric vehicle EV1. It is understood that, in some embodiments, the server 130 may directly or indirectly receive a charging request from a mobile device 140 of the owner of the electric vehicle EV1, and generate a charging authorization command based on the charging request and transmit it to the charging equipment 112 via the network 120, so that the charging equipment 112 outputs power to the electric vehicle EV1, such as an electric scooter or an electric car, which is electrically connected to it, or prohibits the charging equipment 112 from outputting power to the electric vehicle EV1. Note that, in some embodiments, the charging equipment 112 may be bound to a specific account corresponding to the owner of the electric vehicle EV1, and the charging equipment 112 can only accept charging requests corresponding to the specific account. It should be noted that the mobile device 140 can be connected to the server 130 through a first network, and the server 130 can be connected to the electric vehicle charging equipment 112 through a second network. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the charging equipment 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use an RFID card to approach an induction area (not shown in FIG. 1) on the charging equipment 112 to generate a corresponding charging request, and sent it to the server 130 via the network 120. It is reminded that, in some embodiments, each user can have an RFID card.

It is noted that, the mobile device 140 may be corresponded to the owner of the electric vehicle, which can be any electronic device capable of Internet access, such as mobile devices, such as mobile phones, smart phones, personal digital assistants, global positioning systems, and notebook computers. In some embodiments, the mobile device 140 can receive status information and notifications of the corresponding charging operation from the cloud management server 130 via the network 120. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

As mentioned, the charging field 110 may have a power limit. It is understood that, the server 130 can perform a load adjustment operation for the electric vehicle charging stations according to at least one energy management scheme. Specifically, the server 130 can generate an instruction and send the instruction to the charging equipment 112 via the network 120 to control the charging station to output power for charging with a specified power parameter, such as a specified amperage, during a specific period of time to the electric vehicle connected to the station, or to prohibit the charging station from outputting power to the electric vehicle.

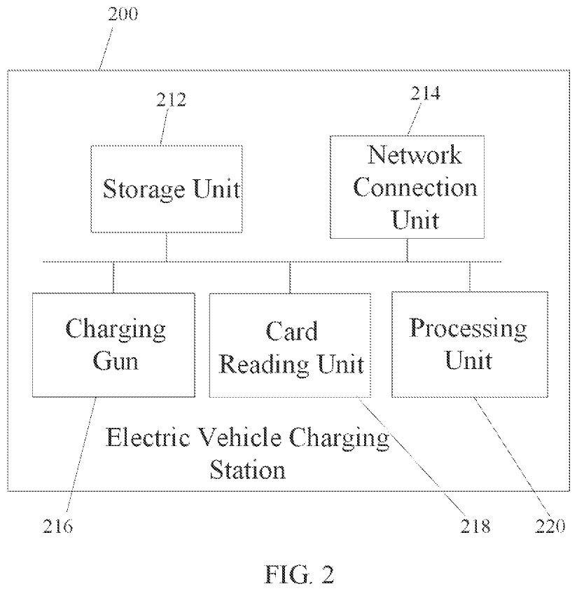

FIG. 2 is a schematic diagram illustrating an embodiment of an electric vehicle charging station of the invention. The electric vehicle charging station 200 shown in FIG. 2 can be applied to the charging equipment 112 in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, a card reading unit 218, and a processing unit 220. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The card reading unit 218 may be an RFID reading unit for sensing information of a physical card, such as RFID card. The information sensed from the RFID card may be a card identification code and/or a user identification code of the physical card. The processing unit 220 can control the operations of related software and hardware in the electric vehicle charging station 200, and cooperate with the server 130 to execute the methods of the invention. Related details will be described later. It is noted that, in some embodiments, the processing unit 220 may be a general-purpose controller, a Micro-Control Unit, MCU, or a Digital Signal Processor, DSP, etc., to provide functions of data analysis, processing and calculation, but the present invention is not limited to this. In one embodiment, the processing unit 220 may use the network connection unit 214 to transmit the power state of the corresponding electric vehicle through a network for a cloud management server, such as the cloud server 130, for subsequent charging management. In another embodiment, the processing unit 220 can obtain the power parameter of a charging operation from the server 130, determine the output power according to the power parameter received from the server 130, and output the power to at least one electric vehicle through the charging gun 216 to perform the charging operation.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

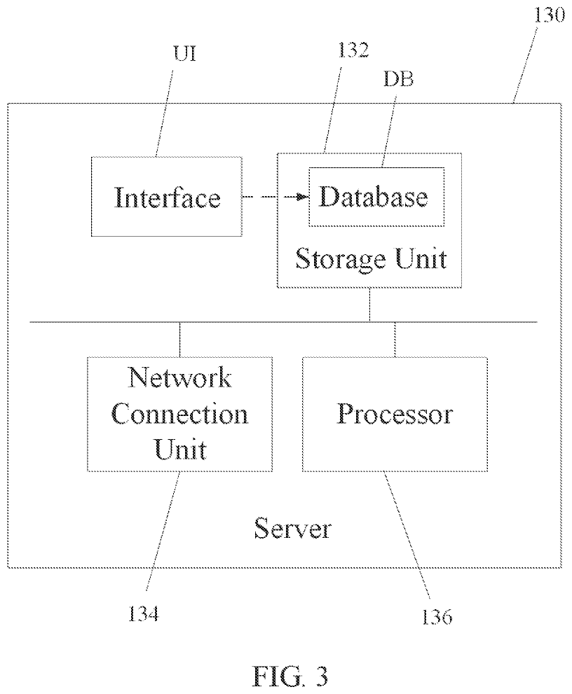

FIG. 3 is a schematic diagram illustrating an embodiment of a server of the invention. As shown in FIG. 3, the server 130 of the invention can be any processor-based electronic device, which comprises at least a storage unit 132, a network connection unit 134, and a processor 136. It is noted that, the server 130 can receive various data corresponding to a plurality of electric vehicle charging equipment in a charging field. The server 130 can directly or indirectly receive a charging request from a mobile device or a charging station, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 132 such as a memory, can store and record related data, such as various data of the corresponding electric vehicle charging equipment. The storage unit 132 may include a database DB for recording accounts bound to the corresponding electric vehicle charging equipment and account information thereof. It is understood that, in some embodiments, the respective electric vehicle charging equipment may be bound to an account. In other words, only the bound account can exclusively use the electric vehicle charging equipment. In some embodiments, the database DB can further record the payment information corresponding to the account bound to the electric vehicle charging equipment, the details of which will be described later. It is reminded that, in some embodiments, the server 130 may provide an interface UI for the user bound to the electric vehicle charging equipment to set the aforementioned data. Through the network connection unit 134, the server 130 can be coupled and communicated with the respective electric vehicle charging equipment via the network 120, such as a wired network, a telecommunication network, and a wireless network, such as a Wi-Fi network. The relevant data/signals/commands are transmitted to the electric vehicle charging equipment via the network 120 to control whether the electric vehicle charging equipment outputs electric power and specify the electric parameters to output electric power to charge the electric vehicle. The processor 136 can control the operations of the relevant software and hardware in the server 130, and execute the management methods for electric vehicle charging equipment of the present invention, the details of which will be described later. It should be noted that, in some embodiments, the processor 136 may be a general-purpose controller, a microcontroller, or a digital signal controller, etc., for providing data analysis, processing, and computing functions, but the present invention is not limited thereto.

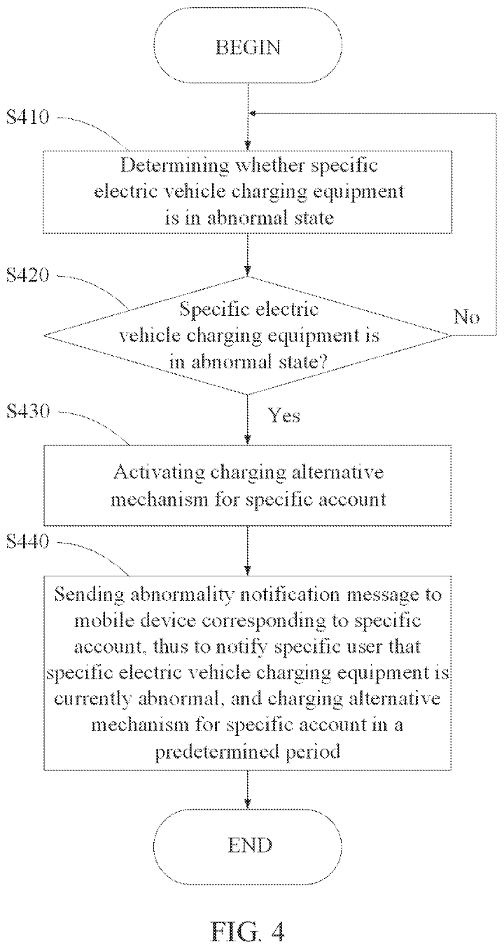

FIG. 4 is a flowchart of an embodiment of a management method for electric vehicle charging equipment of the invention. The management method for electric vehicle charging equipment of the invention is applicable to a specific electric vehicle charging equipment and a server.

In step S410, the server determines whether the specific electric vehicle charging equipment is in an abnormal state. It is noted that, the specific electric vehicle charging equipment can be bound to a specific account, and can only accept charging requests corresponding to the specific account. It should be noted that, in some embodiments, the server may determine whether the specific electric vehicle charging equipment is in the abnormal state according to the information received from the specific electric vehicle charging equipment via the network. In some embodiments, when the specific electric vehicle charging equipment encounters high/low current, leakage, network instability, or other abnormal events, the specific electric vehicle charging equipment can transmit relevant information back to the server. It should be reminded that, the aforementioned abnormal situation is an example of this case, and the present invention is not limited to this. When the specific electric vehicle charging equipment is not in an abnormal state (No in step S420), the determination in step S410 is continued. When the specific electric vehicle charging equipment is in an abnormal state (Yes in step S420), in step S430, the server activates a charging alternative mechanism for the specific account. The charging alternative mechanism will be discussed later. Then, in step S440, the server transmits an abnormality notification message to a mobile device corresponding to the specific account via a network. The abnormality notification message can be used to notify a specific user of the specific account that the specific electric vehicle charging equipment is currently abnormal, and the charging alternative mechanism for the specific account in a predetermined period. It is understood that, in some embodiments, the server can determine whether the specific electric vehicle charging equipment has returned to the normal state. When the specific electric vehicle charging equipment returns to the normal state, the server cancels the charging alternative mechanism for the specific account.

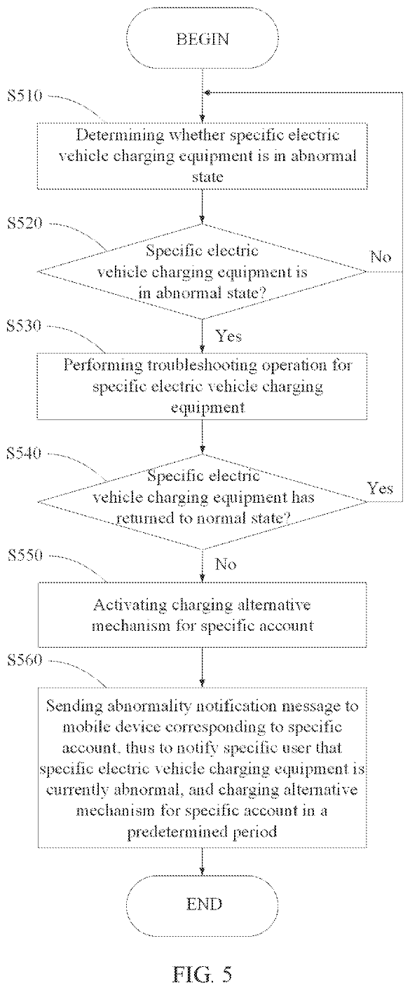

FIG. 5 is a flowchart of another embodiment of a management method for electric vehicle charging equipment of the invention. The management method for electric vehicle charging equipment of the invention is applicable to an electric vehicle charging equipment and a server. In this embodiment, when the electric vehicle charging equipment is abnormal, the server can cause the electric vehicle charging equipment to perform a troubleshooting operation to restore the normal state.

In step S510, the server determines whether a specific electric vehicle charging equipment is in an abnormal state. Note that the specific electric vehicle charging equipment can be bound to a specific account, and can only accept charging requests corresponding to the specific account. Similarly, in some embodiments, the server may determine whether the specific electric vehicle charging equipment is in an abnormal state according to the information received from the specific electric vehicle charging equipment via the network. In some embodiments, when the specific electric vehicle charging device encounters high/low current, leakage, network instability, or other abnormal events, the specific electric vehicle charging device can transmit relevant information back to the server. It should be reminded that the aforementioned abnormal situation is an example of this case, and the present invention is not limited to this. When the specific electric vehicle charging equipment is not in an abnormal state (No in step S520), the determination in step S510 is continued. When the specific electric vehicle charging equipment is in an abnormal state (Yes in step S520), in step S530, the server performs a troubleshooting operation for the specific electric vehicle charging equipment. It should be noted that, in some embodiments, in the troubleshooting operation, a restart command can be transmitted to the specific electric vehicle charging equipment via a network, so as to instruct the specific electric vehicle charging equipment to perform a restart operation. Then, in step S540, the server determines whether the specific electric vehicle charging equipment is restored to a normal state. When the specific electric vehicle charging equipment returns to the normal state (Yes in step S540), the flow returns to step S510. When the specific electric vehicle charging equipment does not return to the normal state (No in step S540), in step S550, the server activates the charging alternative mechanism for the specific account, and in step S560, the server transmits an abnormality notification message to a mobile device corresponding to the specific account via a network. The abnormality notification message can be used to notify a specific user of the corresponding specific account that the specific electric vehicle charging equipment is currently abnormal, and the charging alternative mechanism for the specific account in a predetermined period. Similarly, in some embodiments, the server may determine whether the specific electric vehicle charging equipment has returned to a normal state. When the specific electric vehicle charging equipment returns to the normal state, the server cancels the charging alternative mechanism for the specific account.

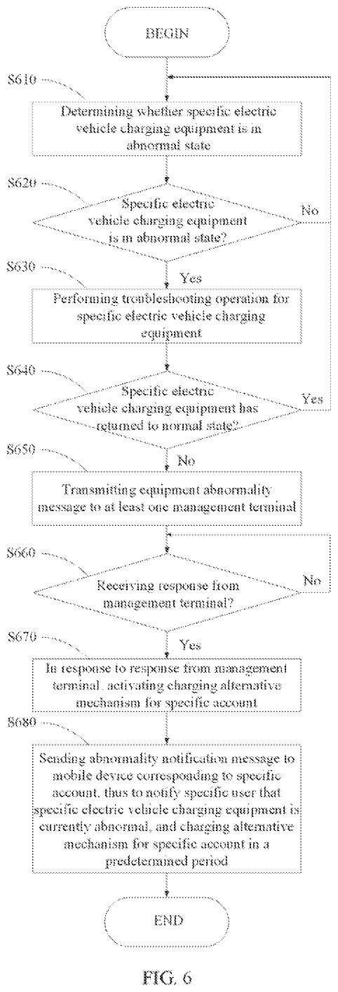

FIG. 6 is a flowchart of another embodiment of a management method for electric vehicle charging equipment of the invention. The management method for electric vehicle charging equipment of the invention is applicable to an electric vehicle charging equipment and a server. In this embodiment, when the electric vehicle charging equipment is abnormal, the server can cause the electric vehicle charging equipment to perform a troubleshooting operation to restore the normal state. When the electric vehicle charging equipment is still in an abnormal state, the server can start the charging alternative mechanism according to the response of a management terminal.

In step S610, the server determines whether a specific electric vehicle charging equipment is in an abnormal state. Note that the specific electric vehicle charging equipment can be bound to a specific account, and can only accept charging requests corresponding to the specific account. Similarly, in some embodiments, the server may determine whether the specific electric vehicle charging equipment is in an abnormal state according to the information received from the specific electric vehicle charging equipment via the network. In some embodiments, when the specific electric vehicle charging device encounters high/low current, leakage, network instability, or other abnormal events, the specific electric vehicle charging device can transmit relevant information back to the server. It should be reminded that the aforementioned abnormal situation is an example of this case, and the present invention is not limited to this. When the specific electric vehicle charging equipment is not in an abnormal state (No in step S620), the determination in step S610 is continued. When the specific electric vehicle charging equipment is in an abnormal state (Yes in step S620), in step S630, the server performs a troubleshooting operation for the specific electric vehicle charging equipment. It should be noted that, in some embodiments, in the troubleshooting operation, a restart command can be transmitted to the specific electric vehicle charging equipment via a network, so as to instruct the specific electric vehicle charging equipment to perform a restart operation. Then, in step S640, the server determines whether the specific electric vehicle charging equipment is restored to a normal state. When the specific electric vehicle charging equipment returns to the normal state (Yes in step S640), the flow returns to step S610. When the specific electric vehicle charging equipment does not return to the normal state (No in step S640), in step S650, the server sends an equipment abnormality message to at least one management terminal. The equipment abnormality message comprises the information of the specific electric vehicle charging equipment. Then, in step S660, it is determined whether a response is received from the management terminal. It is reminded that the relevant management personnel can decide how to eliminate the abnormal problem of the specific electric vehicle charging equipment according to the information received by the management terminal, and determine the response sent back to the server according to the time required to eliminate the abnormality. When no response from the management terminal is received (No in step S660), the determination in step S660 is continued. When a response from the management terminal is received (Yes in step S660), in step S670, in response to the response from the management terminal, the server activates a charging alternative mechanism for the specific account, and in step S680, the server transmits an abnormality notification message to a mobile device corresponding to the specific account via a network. The abnormality notification message can be used to notify a specific user of the corresponding specific account that the specific electric vehicle charging equipment is currently abnormal, and the charging alternative mechanism of the corresponding specific account in a predetermined period. Similarly, in some embodiments, the server may determine whether the specific electric vehicle charging equipment has returned to a normal state. When the specific electric vehicle charging equipment returns to the normal state, the server cancels the charging alternative mechanism for the specific account.

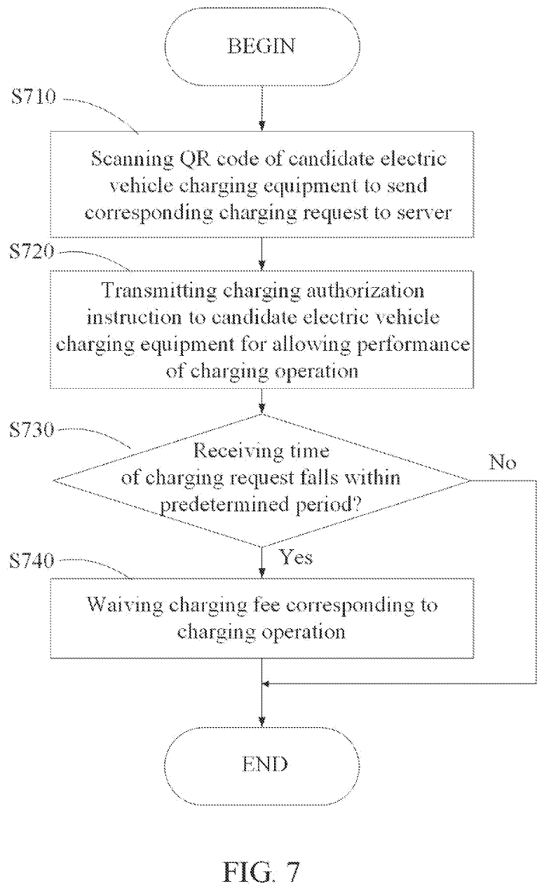

FIG. 7 is a flowchart of an embodiment of a charging alternative mechanism of the invention. In this embodiment, the charging alternative mechanism may be a charging fee waiver mechanism to waive charging fees incurred by a specific account within a predetermined period.

In step S710, a mobile device scans a QR code corresponding to at least one candidate electric vehicle charging equipment by using an application program, so as to send a charging request of the corresponding candidate electric vehicle charging equipment to the server via the network. The mobile device or the application program may correspond to a specific account, and the charging request comprises the information of the specific account. It is worth noting that, in some embodiments, the server may retrieve the information of the at least one candidate electric vehicle charging equipment according to a location of a specific electric vehicle charging equipment or a historical charging record corresponding to the specific account, and transmit the information of the at least one candidate electric vehicle charging equipment to the mobile device via the network. In some embodiments, the candidate electric vehicle charging equipment may be an electric vehicle charging equipment in the form of fast charging and/or slow charging. In step S720, the server transmits a charging authorization instruction to the candidate electric vehicle charging equipment via the network, so as to allow the candidate electric vehicle charging equipment to perform a charging operation. In step S730, the server determines whether a receiving time for receiving a charging request falls within a predetermined period of the charging alternative mechanism. When the time when the charging request is received does not fall within the predetermined period (No in step S730), the process ends. It is reminded that, in some embodiments, when the receiving time of receiving the charging request does not fall within the predetermined period, the server may calculate the charging fee according to the charging logic of the general charging operation. When the receiving time of receiving the charging request falls within the predetermined period (Yes in step S730), a charging fee for the charging operation of the corresponding specific account within the predetermined period is waived.

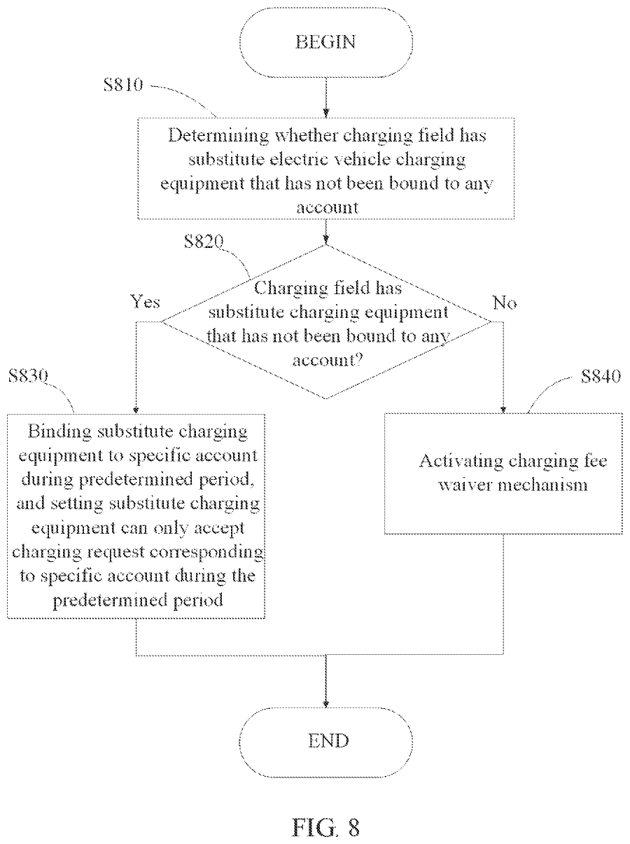

FIG. 8 is a flowchart of another embodiment of a charging alternative mechanism of the invention. In this embodiment, the charging alternative mechanism may be an equipment substitution mechanism to bind other electric vehicle charging equipment to a specific account for temporarily use.

In step S810, the server determines whether there is a substitution electric vehicle charging equipment in the charging field corresponding to the specific electric vehicle charging equipment that has not been bound to any account. When there is a substitution electric vehicle charging equipment that has not been bound to any account in the charging field (yes in step S820), in step S830, the server binds the substitution electric vehicle charging equipment to a specific account within a predetermined period, and sets the substitution electric vehicle charging equipment can only accept the charging request corresponding to the specific account within the predetermined period. When there is no substitution electric vehicle charging equipment that has not been bound to any account in the charging field (No in step S820), in step S840, the server activates the charging fee waiver mechanism as shown in the embodiment in FIG. 7, the details of which are omitted here.

The management methods and systems for electric vehicle charging equipment can provide an alternative mechanism when the charging equipment exclusive for a user is abnormal. In communities or other fields where it is not easy to set up electric vehicle charging stations, the invention can help reduce the difficulty of setting up and managing electric vehicle charging stations. At the same time, when the equipment is abnormal, it will continue to provide charging alternatives to meet the charging needs of users and maintain the long-term loyalty and satisfaction of users.

Management methods for electric vehicle charging equipment may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A management method for electric vehicle charging equipment, which is applicable to a server, comprising:
determining whether a specific electric vehicle charging equipment is in an abnormal state by the server, wherein the specific electric vehicle charging equipment is bound to a specific account and can only accept a charging request from the specific account;
activating a charging alternative mechanism for the specific account when the specific electric vehicle charging equipment is in an abnormal state; and
sending an abnormality notification message to a mobile device corresponding to the specific account via a network, wherein the abnormality notification message is used to notify a specific user of the specific account that the specific electric vehicle charging equipment is currently abnormal, and the charging alternative mechanism for the specific account in a predetermined period.

2. The method of claim 1, further comprising:
performing a troubleshooting operation for the specific electric vehicle charging equipment by the server when the specific electric vehicle charging equipment is in the abnormal state, wherein the troubleshooting operation comprises a step of sending a restart command to the specific electric vehicle charging equipment via the network, thus to instruct the specific electric vehicle charging equipment to perform a restart operation;
determining whether the specific electric vehicle charging equipment has returned to a normal state; and
activating the charging alternative mechanism for the specific account by the server when the specific electric vehicle charging equipment does not return to the normal state.

3. The method of claim 2, further comprising:
sending an equipment abnormality message to at least one management terminal when the specific electric vehicle charging equipment does not return to the normal state, wherein the equipment abnormality message comprises information corresponding to the specific electric vehicle charging equipment; and
in response to a response from the management terminal, activating the charging alternative mechanism for the specific account by the server.

4. The method of claim 1, wherein the charging alternative mechanism comprises a charging fee waiver mechanism, and the method further comprises:
scanning a quick response code corresponding to at least one candidate electric vehicle charging equipment by the mobile device to send a charging request corresponding to the candidate electric vehicle charging equipment to the server via the network, wherein the charging request comprises the information corresponding to the specific account;
transmitting a charging authorization instruction to the candidate electric vehicle charging equipment via the network by the server to allow the candidate electric vehicle charging equipment to perform a charging operation;
determining whether a receiving time of receiving the charging request falls within the predetermined period; and
waiving a charging fee corresponding to the charging operation when the receiving time of receiving the charging request falls within the predetermined period.

5. The method of claim 4, further comprising:
retrieving the at least one candidate electric vehicle charging device by the server according to a location of the specific electric vehicle charging equipment or a historical charging record corresponding to the specific account; and
transmitting information corresponding to the at least one candidate electric vehicle charging equipment to the mobile device by the server via the network.

6. The method of claim 1, wherein the charging alternative mechanism comprises an equipment substitution mechanism, and the method further comprises:
determining whether a charging field corresponding to the specific electric vehicle charging equipment has a substitute electric vehicle charging equipment that has not been bound to any account; and
binding the substitute electric vehicle charging equipment to the specific account during the predetermined period, and setting the substitute electric vehicle charging equipment can only accept the charging request corresponding to the specific account during the predetermined period when there is the substitute electric vehicle charging equipment that has not been bound to any account in the charging field.

7. The method of claim 1, further comprising:
determining whether the specific electric vehicle charging equipment has returned to a normal state by the server; and
canceling the charging alternative mechanism corresponding to the specific account by the server when the specific electric vehicle charging equipment returns to the normal state.

8. A management system for electric vehicle charging equipment, comprising:
a mobile device corresponding to a specific user with a specific account;
a specific electric vehicle charging equipment binding to the specific account, and only accepting charging requests corresponding to the specific account; and
a server connecting to the specific electric vehicle charging equipment via a network, determining whether a specific electric vehicle charging equipment is in an abnormal state, activating a charging alternative mechanism for the specific account when the specific electric vehicle charging equipment is in an abnormal state, and sending an abnormality notification message to a mobile device corresponding to the specific account via a network, wherein the abnormality notification message is used to notify a specific user of the specific account that the specific electric vehicle charging equipment is currently abnormal, and the charging alternative mechanism for the specific account in a predetermined period.

9. The system of claim 8, wherein the server further performs a troubleshooting operation for the specific electric vehicle charging equipment when the specific electric vehicle charging equipment is in the abnormal state, wherein the troubleshooting operation comprises a step of sending a restart command to the specific electric vehicle charging equipment via the network, thus to instruct the specific electric vehicle charging equipment to perform a restart operation, determines whether the specific electric vehicle charging equipment has returned to a normal state, and activates the charging alternative mechanism for the specific account by the server when the specific electric vehicle charging equipment does not return to the normal state.

10. The system of claim 9, wherein the server further sends an equipment abnormality message to at least one management terminal when the specific electric vehicle charging equipment does not return to the normal state, wherein the equipment abnormality message comprises information corresponding to the specific electric vehicle charging equipment, and in response to a response from the management terminal, activates the charging alternative mechanism for the specific account by the server.

11. The system of claim 8, wherein the charging alternative mechanism comprises a charging fee waiver mechanism, and the mobile device further scans a quick response code corresponding to at least one candidate electric vehicle charging equipment to send a charging request corresponding to the candidate electric vehicle charging equipment to the server via the network, wherein the charging request comprises the information corresponding to the specific account, and the server transmits a charging authorization instruction to the candidate electric vehicle charging equipment via the network to allow the candidate electric vehicle charging equipment to perform a charging operation, determines whether a receiving time of receiving the charging request falls within the predetermined period, and waives a charging fee corresponding to the charging operation when the receiving time of receiving the charging request falls within the predetermined period.

12. The system of claim 11, wherein the server further retrieves the at least one candidate electric vehicle charging device according to a location of the specific electric vehicle charging equipment or a historical charging record corresponding to the specific account, and transmits information corresponding to the at least one candidate electric vehicle charging equipment to the mobile device via the network.

13. The system of claim 8, wherein the charging alternative mechanism comprises an equipment substitution mechanism, and the server further determines whether a charging field corresponding to the specific electric vehicle charging equipment has a substitute electric vehicle charging equipment that has not been bound to any account, and binds the substitute electric vehicle charging equipment to the specific account during the predetermined period, and sets the substitute electric vehicle charging equipment can only accept the charging request corresponding to the specific account during the predetermined period when there is the substitute electric vehicle charging equipment that has not been bound to any account in the charging field.

14. The system of claim 8, wherein the server further determines whether the specific electric vehicle charging equipment has returned to a normal state, and cancels the charging alternative mechanism corresponding to the specific account when the specific electric vehicle charging equipment returns to the normal state.

15. A machine-readable storage medium comprising a computer program, which, when executed, causes a device to perform an management method for electric vehicle charging equipment, which is applicable to a server, wherein the method comprises:
determining whether a specific electric vehicle charging equipment is in an abnormal state by the server, wherein the specific electric vehicle charging equipment is bound to a specific account and can only accept a charging request from the specific account;
activating a charging alternative mechanism for the specific account when the specific electric vehicle charging equipment is in an abnormal state; and
sending an abnormality notification message to a mobile device corresponding to the specific account via a network, wherein the abnormality notification message is used to notify a specific user of the specific account that the specific electric vehicle charging equipment is currently abnormal, and the charging alternative mechanism for the specific account in a predetermined period.
